(19) United States
(12) Patent Application Publication
(10) Pub. No.: US 2008/0106018 A1
(43) Pub. Date: May 8, 2008

(54) PIVOTING HEAD FOR WELDING STAND

(76) Inventor: Bob BELLAVANCE, Rocky Mountain House (CA)

Correspondence Address: SANDER R. GEISING, 600, 4911-51 STREET, RED DEER, AB, T4N-6V4, omitted

(21) Appl. No.: 11/562,885

(22) Filed: Nov. 22, 2006

Related U.S. Application Data
(60) Provisional application No. 60/864,964, filed on Nov. 8, 2006.

(51) Int. Cl. B25B 1/22

(52) U.S. Cl. 269/57

(57) ABSTRACT

The present invention is directed to overcoming stability issues when using welding stands or jacks screw stands to support pipe and other cylindrical objects in horizontally oriented manner by providing a support head or head apparatus which pivots. In one embodiment, the pivoting head apparatus for supporting a cylindrical object having a longitudinal axis comprises a base member and a support member pivotally mounted to the base member so that, in operation, the support member pivots about an axis that is generally perpendicular to the longitudinal axis of a cylindrical object. In another embodiment, the pivoting head apparatus further comprises a plurality of rollers for rollably engaging the cylindrical member. Additional embodiments and a method aspect are also disclosed.

### CROSS REFERENCE TO RELATED APPLICATION

This application is a regular application of U.S. Provisional Patent Application Ser. No. 60/864,964 filed Nov. 8, 2006 and entitled, “PIVOTING HEAD FOR WELDING STAND”, the entirety of which is incorporated herein by reference.

### FIELD OF THE INVENTION

The field of present invention relates generally to a head attachment, or head apparatus, for a welding stand and, more particularly, to a pivoting head apparatus and a method for supporting pipe and other cylindrical members in a horizontally oriented manner to facilitate welding and other operations.

### BACKGROUND OF THE INVENTION

To prepare for the welding and fabrication of metal pipe, welders typically support a particular section of pipe using a plurality of welding stands or jacks placed at appropriate positions underneath the pipe. Each such stand will typically have a support head or head attachment mounted on top to support the pipe. One type of support head may take the form of a V-shaped cradle that receives and centers the pipe to be supported. This type of object support is known in the industry as a “V-head”. Where the pipe is to be supported for rotation, pipe support heads having horizontally arranged, spaced rollers may be employed. This type of object support is referred to as a “roller head”. The rollers facilitate the turning or rolling of the pipe section as the welding is conducted.

One example of such prior art welding stands and heads is the FOLD-A-JACK™ stand manufactured by Sumner Manufacturing Co., Inc. of Houston, Tex., United States. This particular model can be ordered with a V-head, a bar-head or a roller head.

However, the welding stands used in the conventional manner described above have a tendency to tip over under the weight of the pipe section, especially as the pipe is rotated or turned during welding procedure. For example, the inventor has observed that a 10 foot section of 6-inch diameter ¼″ thickness schedule 40 pipe, supported at about waist level above generally level ground by two of the prior art FOLD-A-JACK™ stands each having conventional roller heads (with the two stands position underneath the 10 foot section of pipe each within half-a-foot of the ends of the pipe), will at most accommodate about two or two-and-a-half revolutions of the pipe before the setup becomes unstable and begins to fall over. Likewise, the inventor has observed that a 40 foot section of 8-inch diameter ⅜″ thickness pipe, supported at about waist level above generally level ground by three of the prior art FOLD-A-JACK™ stands each having roller heads (with two of the stands position underneath the 40 foot section of pipe within half-a-foot of the ends of the pipe and the third placed roughly at the mid-way point of the pipe), will only accommodate about half a revolution of the pipe before that setup becomes unstable and begins to fall over.

An advantage therefore exists for a stand and head assembly to safely support metal pipe sections, or other objects, while also allowing for a significant number of revolutions of the pipe and remain stable during such revolutions.

### SUMMARY OF THE INVENTION

In one embodiment, the pivoting head apparatus for supporting a cylindrical object having a longitudinal axis comprises a base member and a support member pivotally mounted to the base member so that, in operation, the support member pivots about an axis that is generally perpendicular to the longitudinal axis of a cylindrical object.

In another embodiment, the pivoting head apparatus further comprises a plurality of rollers for rollably engaging the cylindrical member. Preferably the rollers rotate about an axis which is generally parallel to longitudinal axis of the cylindrical object.

In yet another embodiment, the pivoting head apparatus further comprises a plurality of rollers for rollably engaging the cylindrical member and a V-shaped bracket attachment which is removably attachable over top of the plurality of rollers. The V-shaped bracket attachment pivots in cooperation with the support member during operation as the support member pivots relative to the base member. Advantageously, the V- shaped bracket allows the user of the pivot head to select either a pipe rolling feature (by operating the head with the V-shaped bracket removed) or a non-rolling feature (by operating the head with the V-shaped bracket attached). Additional embodiments and a method aspect are also disclosed.

### BRIEF DESCRIPTION OF THE DRAWINGS

FIGS. 1a-1d are perspective views of one embodiment of the pivoting head according to the present invention, showing various degrees of pivoting of the support member relative to the base member;

FIGS. 2a-2b are exploded perspective and exploded front views, respectively, of the pivoting head of the embodiment of FIG. 1a;

FIGS. 3a-3g are side views of the pivoting head of the embodiment of FIG. 1a, showing various degrees of pivoting of the support member relative to the base member;

FIGS. 4a-4c are perspective views of the pivoting head of the embodiment of FIG. 1a, shown supporting a section of pipe at various degrees of pivoting of the support member relative to the base member;

FIGS. 5a-5c are side views of two pivoting heads of the embodiment of FIG. 1a, shown mounted each on top of a welding stand and supporting a section of pipe;

FIG. 6 is side view of the pivoting head of the embodiment of FIG. 1a, shown mounted on top of a welding stand and supporting one end of a section of pipe;

FIGS. 7a-7m are various views of a second embodiment of the pivoting head;

FIGS. 8 is a perspective view of the embodiment of FIG. 1a;

FIGS. 9a-9b are various views of a third embodiment of the pivoting head; and

FIG. 9c is a side perspective view of two pivoting heads of the embodiment of FIG. 9a, shown mounted each on top of a welding stand and supporting a section of pipe.

### DETAILED DESCRIPTION OF THE PREFERRED EMBODIMENTS

Reference is to be had to the Figures in which identical reference numbers identify similar components.

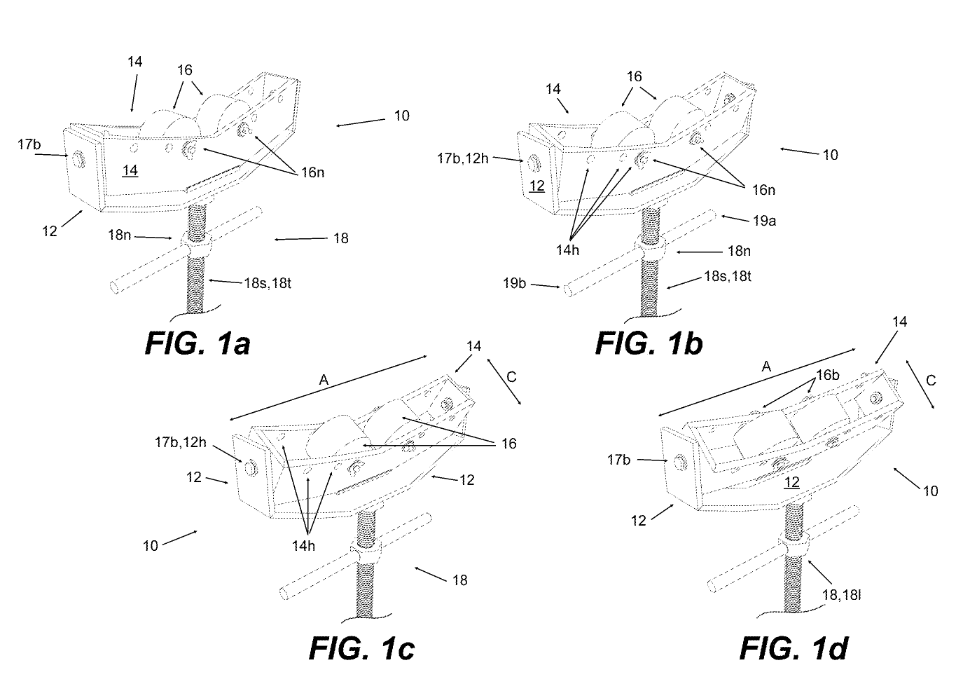

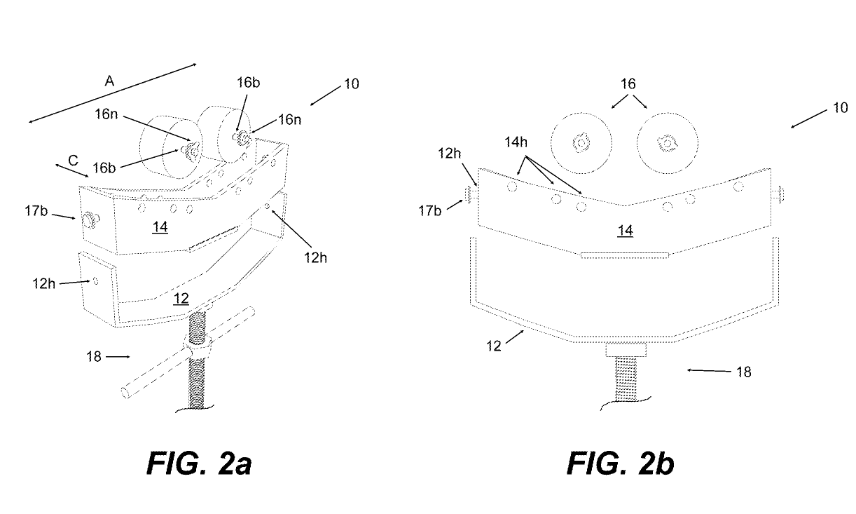

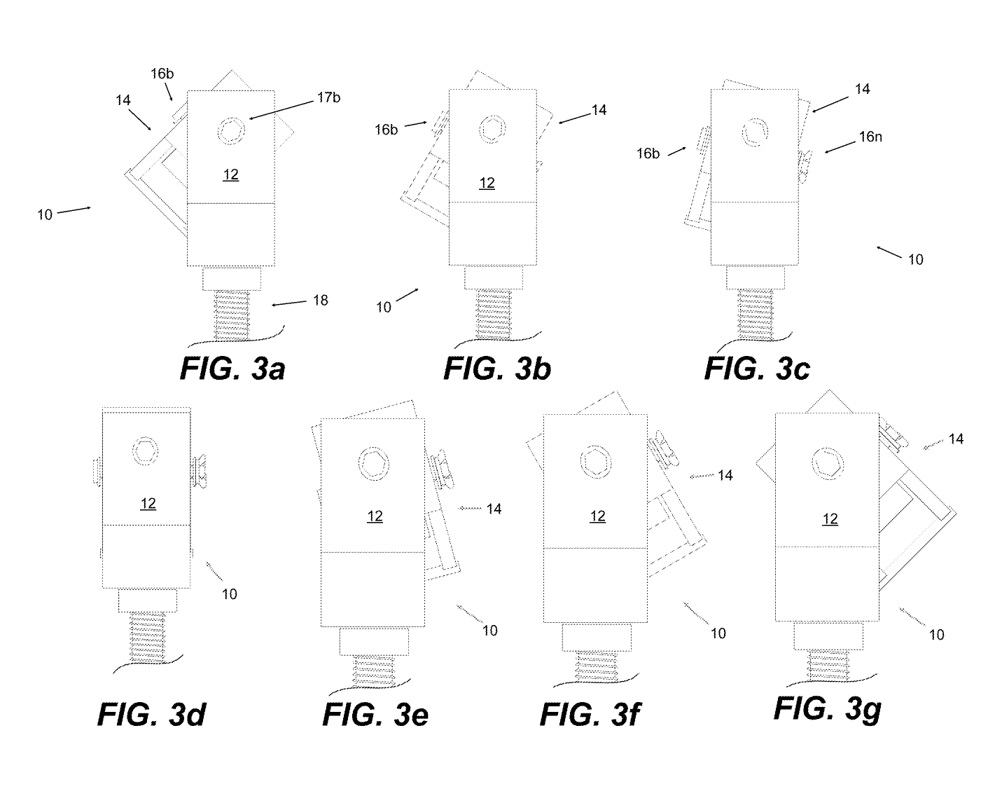

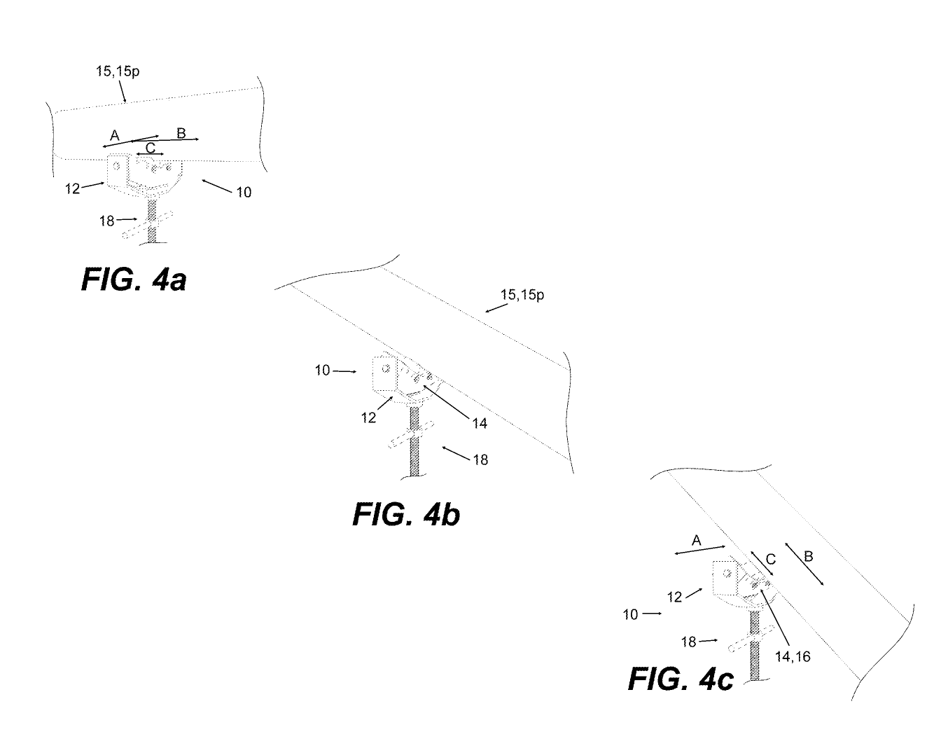

Referring to FIGS. 1-6 and 8, one embodiment of a pivoting head constructed in accordance with the present invention is illustrated generally at 10. The pivoting head 10 is designed to effectively supports all, or part of, a cylindrical object 15 such as a pipe 15p to be welded. The pivoting head 10 comprises a base member 12 and a support member 14 pivotally mounted to the base member 12. Support member 14 is pivotally mounted to the base member 12 so that, in operation, support member 14 pivots about axis A which is generally perpendicular to the longitudinal axis B of the cylindrical object 15, while at the same time supporting said object 15.

Preferably the base member 12 is a U-shaped cradle or saddle for pivotally mounting the support member 14. Alternatively, the base member 12 may take any other suitable form, so as to pivotally mount the support member 14 as described above, without departing from the spirit or scope of this invention. More preferably, support member 14 is pivotally mounted to the base member 12 in a conventional manner. Even more preferably, support member 14 is pivotally mounted to the base member 12 so that the center of gravity of the support member is below pivot axis A.

In this embodiment, support member 14 is pivotally mounted to the base member 12 by a pair of threaded bolts 17b which pass through a pair of pivoting holes 12h (one hole 12h located at either end of the U-shaped cradle of the member 12) and thread into internally threaded openings (not shown) in the support member 14. Alternatively, in another embodiment (not shown) the support member 14 is pivotally mounted to the base member 12 by means of a pair of pins which pass through matching pivoting holes in both members 12, 14, the pins then being held in place by retaining rings or clips. In yet another embodiment (not shown) the support member 14 is pivotally mounted to the base member 12 by means of a pair of pins which pass through matching pivoting holes in both members 12, 14, the pins then subsequently being welded to each member so as to hold them in place.

The support member 14 is of such form so as to effect support of a cylindrical object 15 such as a pipe 15p to be welded. In this embodiment, the support member 14 further comprises a pair of rollers 16 for rollably engaging the cylindrical member 15. The rollers 16 are mounted to the support member 14 so that, in operation, the rollers 16 rotate about axis C which is generally parallel to the objects's longitudinal axis B; thereby facilitating the turning or rolling of the pipe 15p as the welding is conducted.

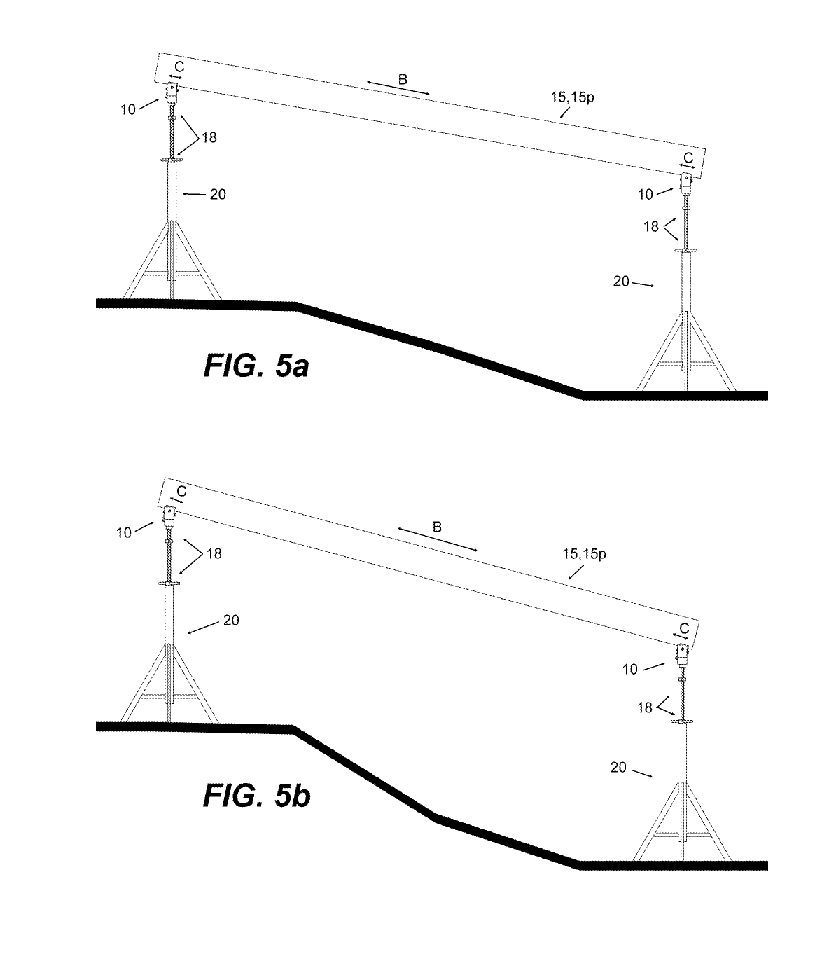

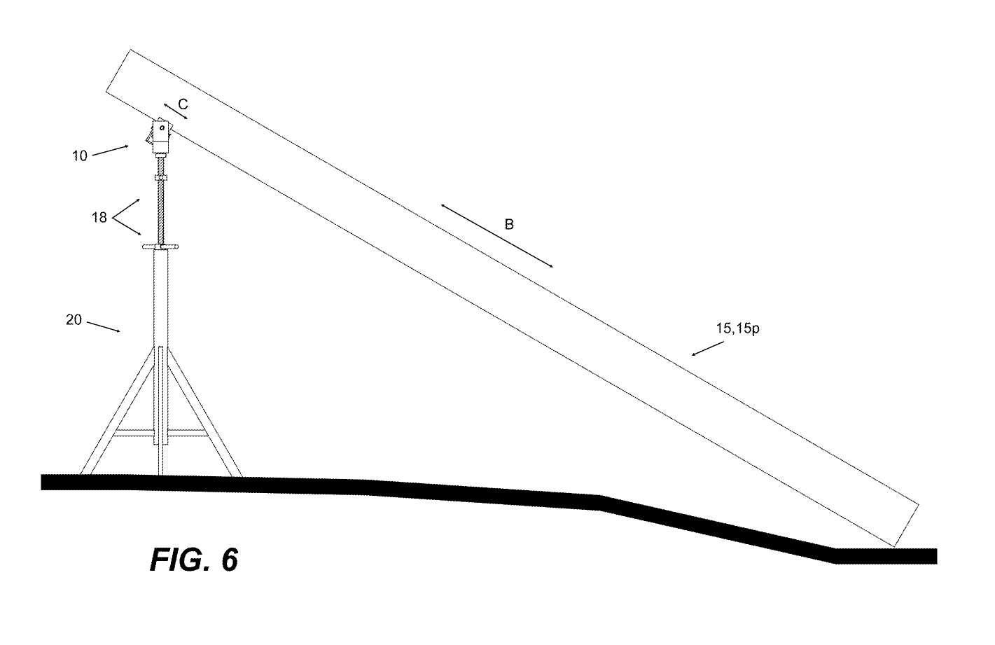

Advantageously, when the support member 14 pivots relative to base member 12 (while the pivot head 10 supports object 15 during operations) the rollers's rotating axis C is kept generally parallel to the objects's longitudinal axis B (see FIGS. 5a-6). Were this not the case, as with prior art roller heads, axis B and C would diverge from each other (i.e. no longer remaining parallel) causing or contributing to the instability found in the prior art stands and support heads.

Preferably, the rollers 16 are mounted to the support member 14 in a conventional manner. In this embodiment, the rollers 16 are mounted to the support member 14 using a nut 16n and bolt 16b combination; the bolt 16b passing through the center of the roller 16 (via a central passage therethrough) and through matching and aligned roller holes 14h in member 14 (see 1a-2b), thereby acting as an axel. Advantageously a plurality of matching and aligned roller holes 14h are provided to allow a user to selectively place the rollers 16 at desired positions on the member 14; thereby allowing the pivoting head 10 to easily adjust to support various diameters of cylindrical objects 15.

Alternatively, in another embodiment (not shown) the rollers 16 are mounted to the support member 14 by means of a pin which passes through the center of the rollers 16 (via a central passage therethrough) and through matching and aligned roller holes in member 14, said pin then being held in place by retaining rings or clips. Alternatively, in yet another embodiment (not shown) the rollers 16 are pivoted to the roller holes of support member 14 by a shaft which projects from the center of either side of the rollers 16.

Alternatively, the support member 14 may take any other suitable form to effectively support all or part of the object 15, including that of a V or U shaped cradle, without departing from the spirit or scope of this invention.

In this embodiment the pivoting head 10 further comprises mounting means 18 suitable for removably mounting the head 10 onto a welding stand 20, screw jack stand or the like. Advantageously, the mounting means 18 allow the pivoting head 10 to be retro-fit onto existing welding stands 20, screw jack stands or the like. In other embodiments (not shown), the pivoting head 10 can be formed as an integral part of the stand or jack by being welded or otherwise fixed thereto.

Preferably the mounting means 18 is in a conventional form and comprises an externally threaded elongate adjustment screw 18s and adjustment nut 18n. In this embodiment the adjustment screw 18s projects downward from the base member 12, the adjustment nut 18n defines internal threads (not shown) which are received by external threads 18t of the adjustment screw 18s and the adjustment nut 18s further comprises a lower load transmitting portion 18l. More preferably, the threads 18t are coarse, acme threads but they may also take any other suitable form. Even more preferably, the adjustment nut 18n is provided with opposed adjusting handles 19a and 19b for ease of manual manipulation.

Mounting or retrofitting the pivoting head 10 of this embodiment to a stand 20 is accomplished in a conventional manner, with at least a portion of the adjustment screw 18s being received within the conventional upward facing, internal opening of the stand 20 and with the lower load transmitting portion 18l of the adjustment nut 18n engaging part or all of the circumference portion around the internal opening of the stand 20. Advantageously, the mounting means 18 of this embodiment enables easy retrofit of the pivot head 10 to existing welding stands, screw jack stands or the like.

### Second Embodiment

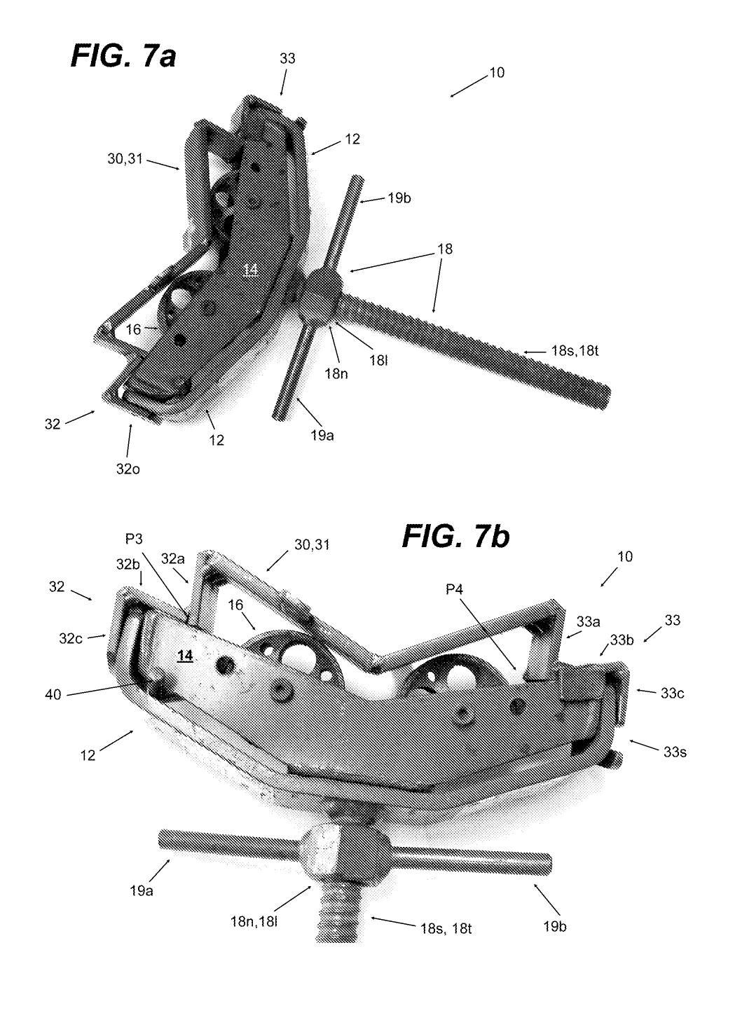

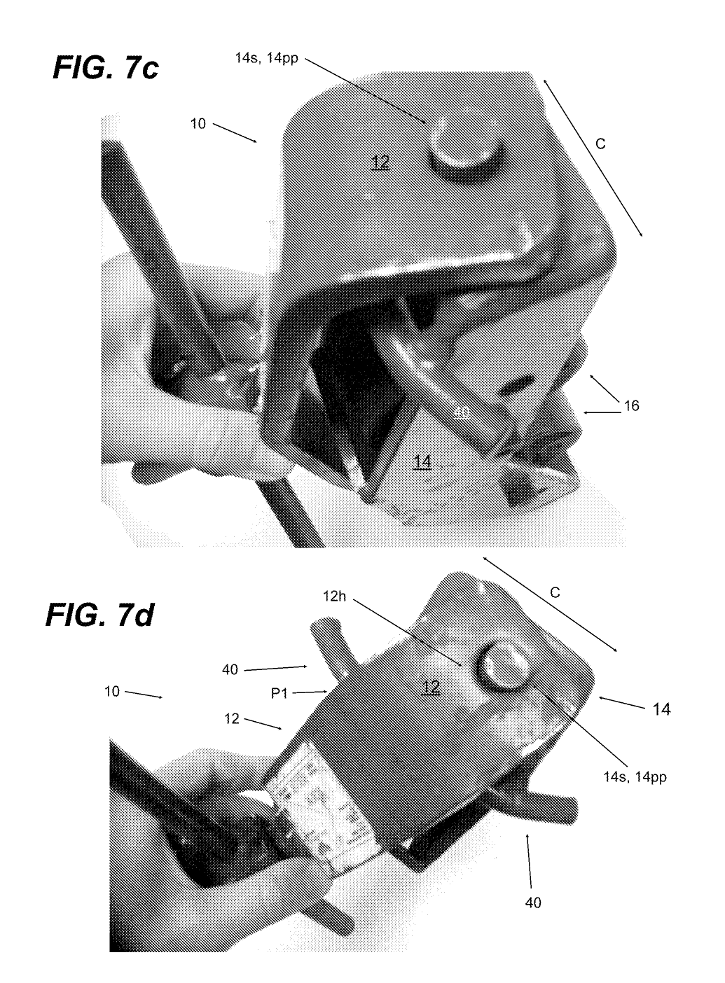

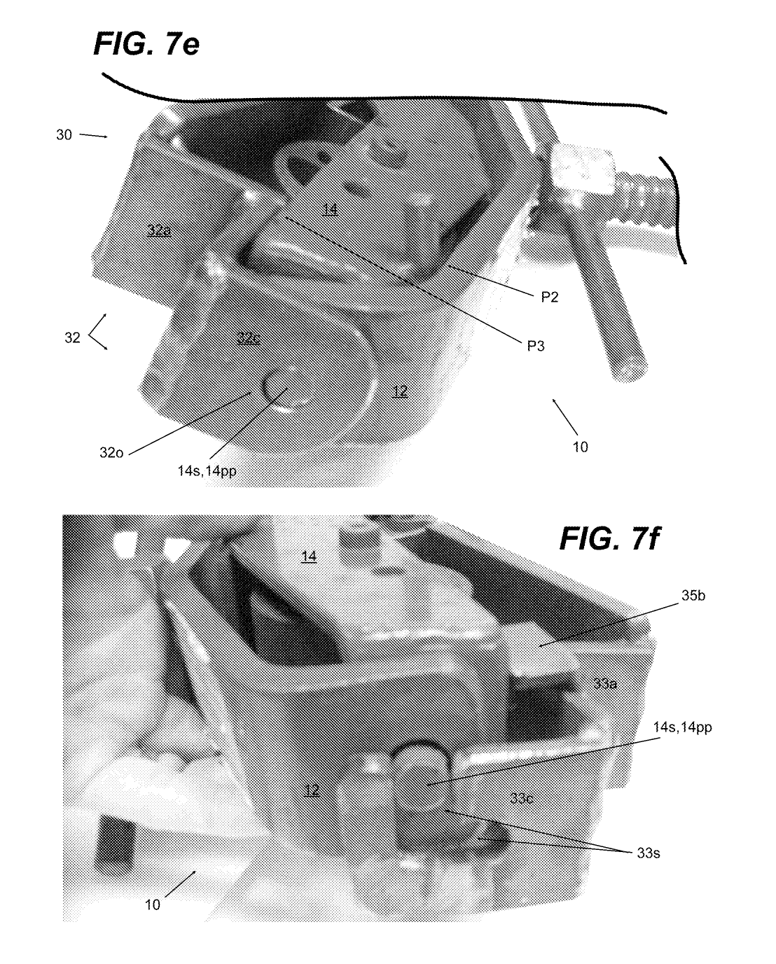

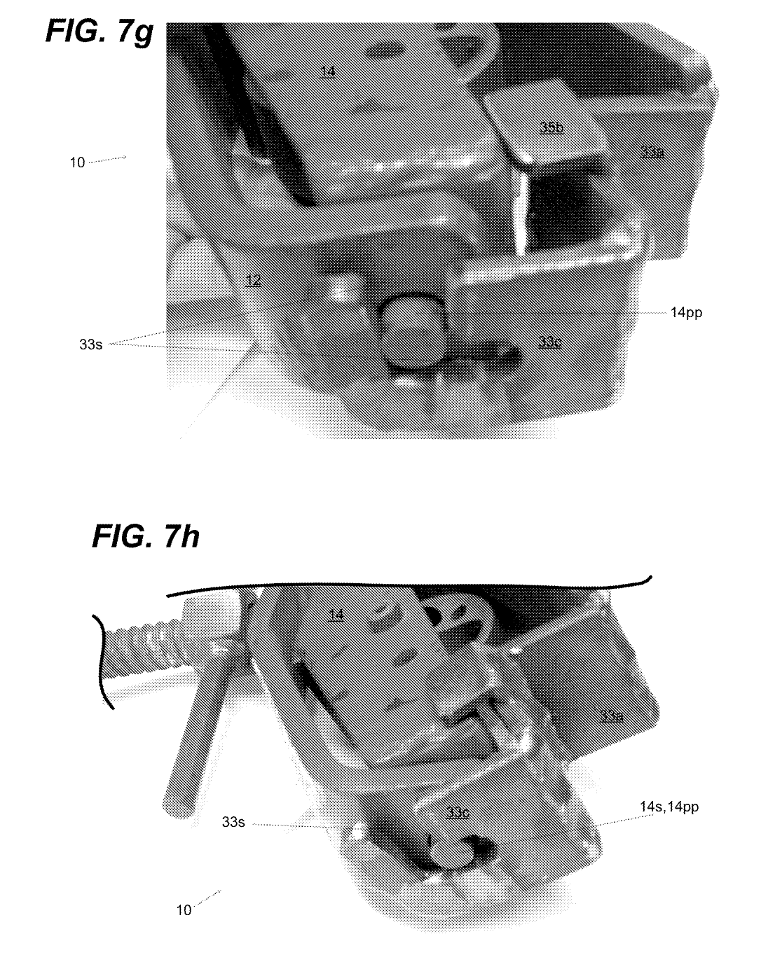

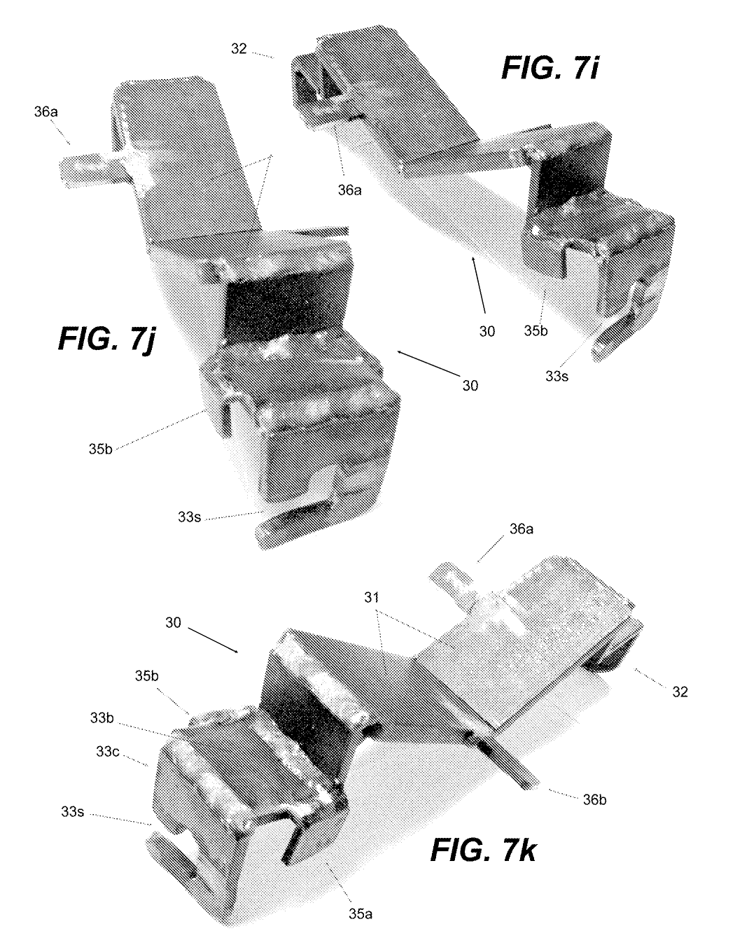

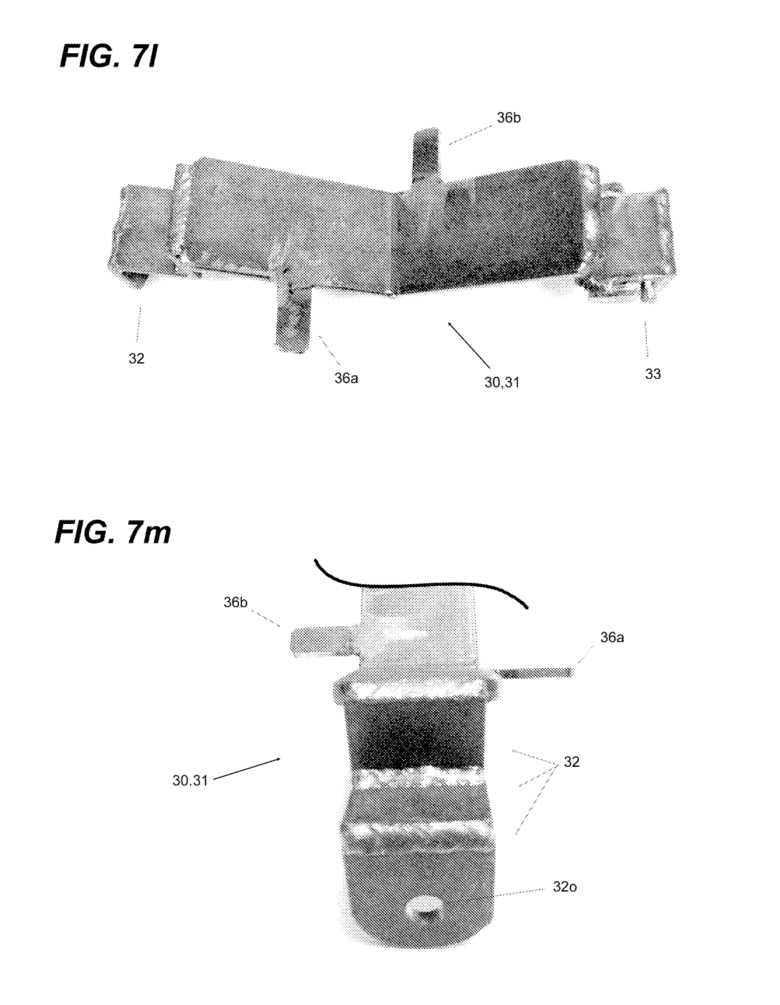

FIGS. 7a to 7m illustrate a second embodiment of the pivoting head 10. This embodiment of the head 10 is similar to the first embodiment as discussed above with the following notable differences.

In this embodiment, support member 14 is pivotally mounted to the base member 12 by a pair of pivoting shafts 14s which project laterally from the support member 14 as shown and pass through a pair of pivoting holes 12h (one hole 12h located at either end of the U-shaped cradle of the base member 12), so as to effect pivotal movement of the support member 14 relative to the base member 12. Preferably, the pivoting shafts 14s project some additional distance past the holes 12h and sides of the base member 12, this additional portion being referred to as the pivoting shafts' projecting portion 14pp. Preferably, each of the projecting portions 14pp project at least ¼ inch past the holes 12h and sides of the base member 12.

The second embodiment further comprises a brake, lug or stop 40 projecting from the support member 14 which will engage the base member 12 when the support member 14 pivots too far about axis A. Advantageously, the brake 40 functions to prevent unwanted excess pivoting movement of the support member relative to the base member. In this embodiment, the brake 40 engages the base member 12 at either point P1 or point P2 (depending on the direction of the pivoting movement) when the support member 14 has pivoted about 25 degrees relative to the base member 12.

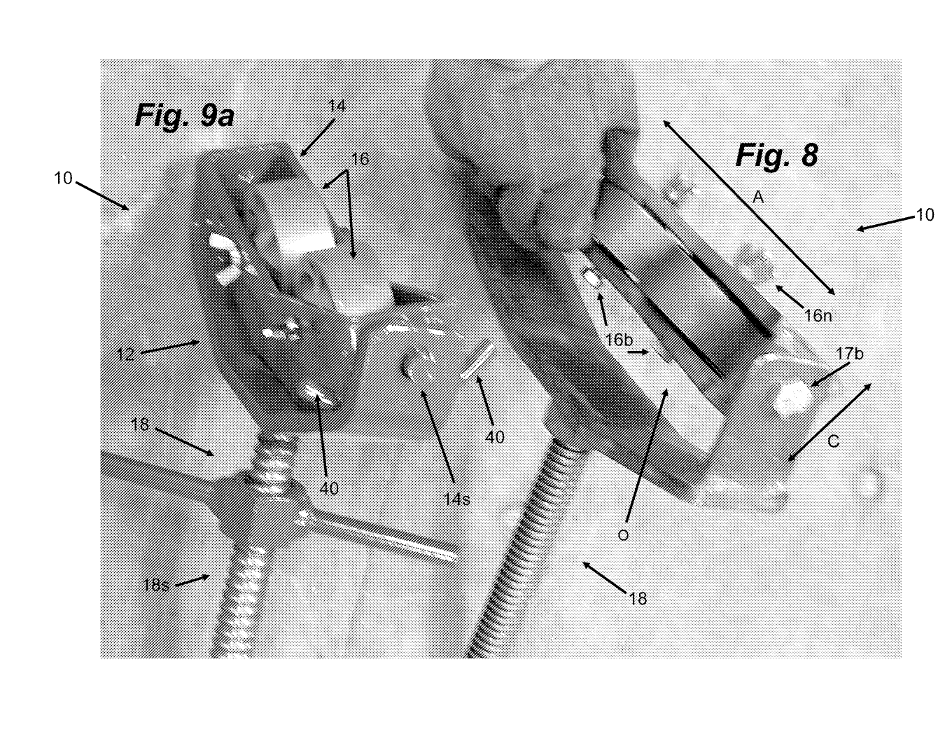

Advantageously, and since typically only a small amount of pivoting action will be required to provide additional stability when supporting the pipe 15p, the brake 40 prevents the support member 14 from making too large a rotational movement about axis A, which in turn may create an opening between the base member 12 and the support member 14, said opening potentially allowing passage of a users's fingers 50 therethrough; and, in such a case, the users's fingers 50 subject to becoming pinched, jammed or clamped between members 12 and 14 as member 14 rotates back. See the embodiment of FIG. 8 for such an opening (labeled O) when the pivot head 10 does not have a break and the support member 14 has pivoted about 70 degrees counterclockwise relative to the base member 12.

The second embodiment further comprises a V-shaped bracket attachment 30 which is removably attachable over top of the rollers 16 of the support member 14 (see FIGS. 7a-7b and 7e-7h for how the V-shaped bracket 30 may be easily mounted on, or removed from, the support member 14). The V-shaped bracket 30 attaches, connects or mounts to the support member 14 so as to pivot in co-operation with the support member 14 during operation, about axis A, as said member 14 pivots relative to the base member 12 (as more clearly shown in FIGS. 7a, 7b and 7e-7h).

In this embodiment, the V-shaped bracket attachment 30 further comprises a V-shaped cradle 31 that receives, supports and centers object 15 and a pair of mounting members 32, 33 on either side of the cradle 31 to facilitate attaching the V-shaped bracket attachment 30 to the support member 14.

Further, in this embodiment, each of the mounting members 32, 33 comprises a first leg element 32a, 33a, a second leg element 32b, 33b and a third leg element 32c, 33c. The first leg elements 32a, 33a project generally downward from each side of the V-shaped cradle and rest on the support member 14 (shown more clearly in FIGS. 7a and 7b) so as to transfer the weight of the object 15 from the cradle 31 to top of the support member 14 generally at points P3 and P4. The second 32b, 33b and third 32c, 33c leg elements each project generally laterally and downward, respectively, from the first leg member 32a, 33a; with the second leg members 32b, 33b projecting just above and along the top of the support member 14 and the third leg members 32c, 33c projecting substantially adjacent the sides of the base member 12 (again, as more clearly shown in FIGS. 7a and 7b).

In this embodiment, mounting member 32 further comprises an opening 320 in third leg member 32c to receive, or fit over, one of the projecting portions 14pp (see FIG. 7e). Further in this embodiment, mounting member 33 further comprises a slot 33s in third leg member 33c to receive, or slide over, the other projecting portion 14pp (see FIG. 7f) on the opposing side of the base member 12. In this embodiment the slot 33s is L-shaped and both the opening 320 and the slot 33s conveniently cooperate with both projection portions 14pp to facilitate attaching the V-shaped bracket attachment 30 to the support member 14 as follows. First, mounting member 32 is position over one side of the support member 14 so that the projecting portion 14pp on that side is received by opening 320 (as shown in FIG. 7e). Next mounting member 33 positioned over the opposite side of the support member 14 so that the projecting portion 14pp on that side is received by slot 33s (see FIG. 7f). Then mounting member 33 is positioned so as to guide the projecting portion 14pp through the slot and towards the end of the L-shape (see FIGS. 7g-7h). Removal of the V-shaped bracket attachment 30 is accomplished by generally reversing these steps.

Advantageously, the V-shaped bracket attachment 30 is mounted to the support member 14 so as to pivot in co-operation with the support member 14 during operation as said member 14 pivots relative to the base member 12. More advantageously, the V-shaped bracket 30 allows the user of the pivot head 10 to select either a pipe rolling feature (by operating the head 10 with the V-shaped bracket 30 removed, as shown more clearly in FIGS. 7c and 7d) or a non-rolling feature (by operating the head 10 with the V-shaped bracket 30 attached, as shown more clearly in FIGS. 7a and 7b).

In this embodiment, the V-shaped bracket attachment 30 further comprises a pair of downward projecting securing tabs 35a, 35b and a pair of gripping tabs 36a, 36b projecting in opposite directions from the cradle 31 at an axis generally parallel to the objects's longitudinal axis B. Advantageously, the securing tabs 35a, 35b facilitate removably attaching the V-shaped bracket attachment 30 over top of the rollers 16 and onto the support member 14 and provide additional securing means to ensure that the V-shaped bracket attachment 30 mounted to the support member 14 cooperates with the support member 14 during operation as said member 14 pivots relative to the base member 12. More advantageously, the gripping tabs 36a, 36b provide a gripping surface for a lockable gripping tool, such as chain vice-grips, to clamp or grip onto; thereby allowing one to use such a lockable gripping tool to quickly and easily fasten a pipe end, that is being supported by the pivoting head 10 and V-shaped bracket attachment 30, to said attachment 30.

### Third Embodiment

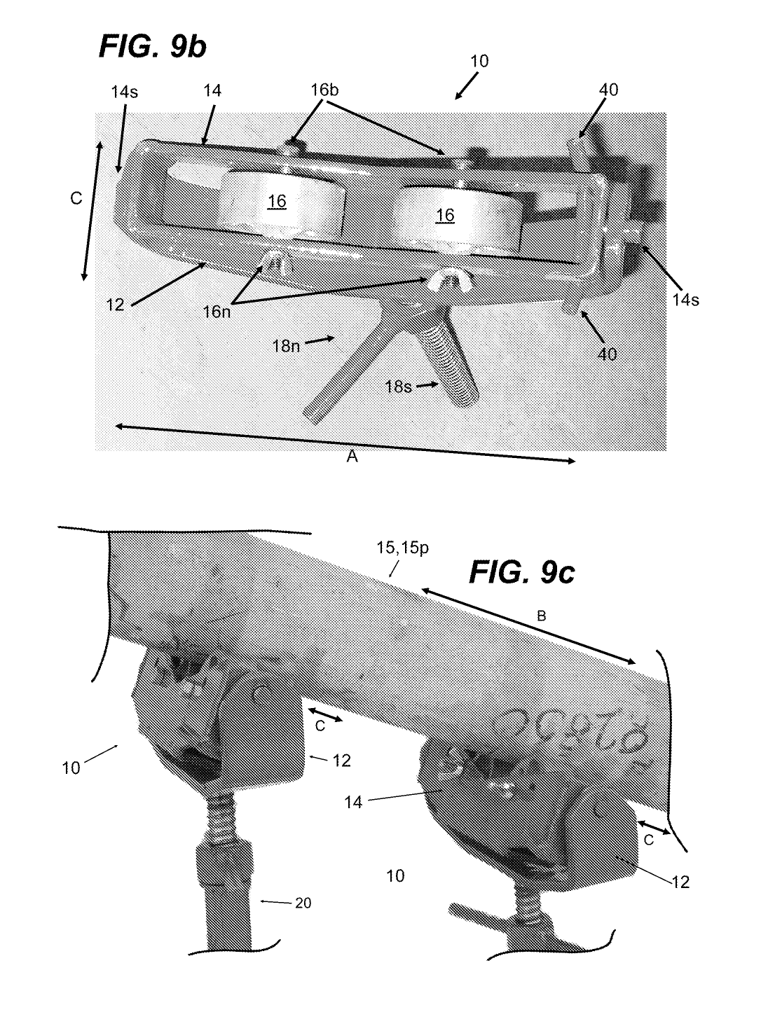

FIGS. 9a to 9c illustrate a third embodiment of the pivoting head 10. This embodiment of the head 10 is similar to the second embodiment as discussed above with the following notable difference. This embodiment does not feature the V-bracket attachment but does comprise a brake or stop 40. Also, in this embodiment, the rollers 16 are mounted to the support member 14 using a nut 16n and bolt 16b combination like that in the first embodiment.

Observations

The inventor has observed that a 10 foot section of 6-inch diameter ¼″ thickness schedule 40 pipe, supported at about waist level above generally level ground by two of the prior art FOLD-A-JACK™ stands each being retro-fit with the pivoting head 10 of the first embodiment (with the two stands and heads 10 positioned underneath the 10 foot section of pipe each within half-a-foot of the ends of the pipe), will now easily accommodate six revolutions of the pipe without the 10 foot section of pipe moving relative to the stands and without the setup becoming unstable or falling over.

The embodiments of the invention in which an exclusive property or privilege is being claimed are defined as follows:

1. A pivoting head apparatus for supporting a cylindrical object having a longitudinal axis, comprising:
a base member; and
a support member pivotally mounted to the base member so that, in operation, the support member pivots about an axis that is generally perpendicular to the longitudinal axis of the cylindrical object.

2. The pivoting head apparatus of claim 1 wherein the support member further comprises a plurality of rollers for rollably engaging the cylindrical object.

3. The pivoting head apparatus of claim 2 wherein the rollers rotate about an axis which is generally parallel to longitudinal axis of the cylindrical object.

4. The pivoting head apparatus of claim 1 wherein the support member further comprises a V-shaped cradle.

5. The pivoting head apparatus of claim 1 further comprising mounting means.

6. The pivoting head apparatus of claim 5 wherein the mounting means comprise:
an elongate adjustment screw having external threads and projecting downward from the base member; and
an adjustment nut having internal threads which are receivable by the external threads of the adjustment screw.

7. The pivoting head apparatus of claim 1 wherein said apparatus is an integral part of a stand.

8. The pivoting head apparatus of claim 1 further comprising a brake projecting from the support member, wherein said brake engages the base member to prevent unwanted excess pivoting movement of the support member relative to the base member.

9. The pivoting head apparatus of claim 2 further comprising a V-shaped bracket attachment removably attachable over top of the rollers to receive and support the cylindrical object, wherein said V-shaped attachment pivots in cooperation with the support member during operation as the support member pivots relative to the base member.

10. A method of supporting a cylindrical object having a longitudinal axis in a generally horizontally oriented manner, the method comprising the steps of:
providing a plurality of stands;
providing a pivoting head apparatus for each of the plurality of stands; and
supporting the cylindrical object with the plurality of stands, each stand having a pivoting head apparatus positioned between said stand and the cylindrical object so as to effect support of the cylindrical object.

11. The method of claim 10 wherein the pivoting head apparatus comprises:
a base member; and
a support member pivotally mounted to the base member so that, in operation, the support member pivots about an axis that is generally perpendicular to the longitudinal axis of the cylindrical object.

12. The method of claim 11 wherein the support member further comprises a plurality of rollers for rollably engaging the cylindrical object.

13. The method of claim 12 wherein the rollers rotate about an axis which is generally parallel to longitudinal axis of the cylindrical object.

14. The method of claim 11 wherein the support member further comprises a V-shaped cradle.

15. The pivoting head apparatus of claim 1 wherein the base member further comprises a U-shaped cradle.

16. The pivoting head apparatus of claim 15 wherein the support member is pivotally mounted to the base member at a pair of pivot points, each one of said pivot points located generally at either end the U-shaped cradle.

17. The pivoting head apparatus of claim 1 wherein the support member is pivotally mounted to the base member so that the center of gravity of the support member is below its pivoting axis.

18. A V-shaped bracket attachment for a roller head apparatus for supporting a cylindrical object and having rollers, said V-shaped bracket attachment removably attachable over top of the rollers.

19. The V-shaped bracket attachment of claim 18 wherein the roller head apparatus is a pivoting roller head apparatus and said V-shaped attachment pivots in cooperation therewith.
